(19) United States
(12) Patent Application Publication
(10) Pub. No.: US 2025/0093535 A1
(43) Pub. Date: Mar. 20, 2025

(54) ELECTRIC CIRCUITRY FOR BASELINE RESTORATION

(71) Applicant: ams International AG, Jona (CH)

(72) Inventors: Massimo RIGO, Trieste (IT); Fridolin MICHEL, Au (CH); Roger STEADMAN BOOKER, Aachen (DE)

(21) Appl. No.: 18/727,694

(22) PCT Filed: Dec. 7, 2022
(86) PCT No.: PCT/EP2022/084822

§ 371 Date: Jul. 10, 2024

(30) Foreign Application Priority Data
Jan. 13, 2022 (DE) 10 2022 100 715.4

(51) Int. Cl. G01T 1/24

(52) U.S. Cl. CPC G01T 1/247

(57) ABSTRACT

Disclosed herein are devices, systems, and methods for baseline restoration. An electric circuitry for baseline restoration includes a baseline sampling circuit for providing a baseline output signal representing a baseline level of an input signal, and an integrator circuit to receive an error signal representing an error of the baseline level of the input signal and to provide an integrator output signal being a representation of an integration of the error signal. The electric circuitry further includes a digitization circuit to provide a digital output signal being a digital representation of the integrator output signal, and an output stage to provide a baseline restoration output signal representing a corrected baseline level of the input signal.

### TECHNICAL FIELD

The disclosure relates to an electric circuitry for baseline restoration which may be used, for example in a photon counting system, such as a multi-energy spectral CT (Computed Tomography). The disclosure further relates to a photon counting circuitry, and a device for medical diagnostics.

### BACKGROUND

In a conventional X-ray sensor, an indirect detection principle is used to detect a photon which passes easily through soft tissues of a body of a patient. Indirect detectors comprise a scintillator to convert X-rays to visible light which is captured by a photodetector or photodiode to provide an electrical signal in response to the X-rays impinging on the material of the scintillator.

In a photon counting system, a direct detection principle is used, which allows to detect and count single photon events in order to obtain intensity and spectral information. Whereas in a classical image or X-ray sensor system only the total input intensity is measured, in a photon counting system the photon energy can also be extracted because photons are detected individually.

FIG. 1 shows a block diagram of a photon counting circuitry 1 comprising a front-end electronic circuitry 10, a photon detector 20, an energy discriminator 30, and a counter 40.

The photon detector 20 generates a transient current pulse Ipulse caused by a photon impinging a photosensitive area 21 of the photon detector 20. Detection of single photons is enabled by a special sensor material of the photosensitive area 21 (typically CdTe or CdZnTe for X-ray conversion), which converts photons into current pulses Ipulse. The front-end electronic circuitry 10 receives an input signal Iin having current pulses Ipulse generated by the photon detector 20 at an input node I10 of the front-end electronic circuitry 10. The front-end electronic circuitry 10 converts the input signal Iin to a front-end output signal Vout_FE having voltage pulses/peaks Vpulse generated at an output node O10 of the front-end electronic circuitry 10. Voltage pulses/peaks Vpulse in the voltage domain at the output node O10 correspond to the current pulses Ipulse at the input node I10 in the current domain.

The height of an output voltage peak is proportional to the photon energy, thus containing spectral information. Digitization of the spectral information (output pulse height) can be performed using the energy discriminator 30, for example a flash ADC, which comprises several comparator circuits 30a, . . . , 30n with different thresholds Vth1, . . . , VthN. The output signals of the comparator circuits are then individually counted by counter circuits 40a, . . . , 40n of the counter 40 in order to obtain a spectral distribution.

The static frontend output voltage of the front-end electronic circuitry 10 in the absence of current pulses at its input is called baseline signal and serves as a reference for the discrimination of the pulse heights by the comparator circuits 30a, . . . , 30n of the energy discriminator 30. As a consequence, changes of the baseline have a direct impact on the observed count rate and pulse energy measurement.

In the case of a DC path from the input node I10 of the front-end electronic circuitry 10 to the output O10 of the front-end electronic a detector leakage current Iin leakage can directly affect baseline stability, so that the baseline must be stabilized in a feedback loop including a circuitry 50′ for baseline restoration.

The circuitry 50′ for baseline restoration may use a sampled based system which performs baseline estimation in the ideal case at times of no pulse activity, i.e. no incident photons, as illustrated in FIG. 2. Provided an appropriate algorithm can be implemented to find timeslots of no pulse activity, the baseline can be ideally extracted without artefacts and provided as baseline output signal Vbase. The output signal Vbase can be fed to a clocked integrator and converted into a correction current IBLR that is applied to the input node I10 of the front-end electronic circuitry 10, as shown in FIG. 1.

Assuming long periods of high pulse activity, the integrator cannot be refreshed, which causes droop in the integrator output voltage, which in turn results in significant baseline droop during high pulse activity. Since the baseline droop corresponds to a drift of the energy scale, the baseline droop can cause image artefacts in an application and significantly impact the spectral accuracy of a detector. Upon change from high to low activity the baseline must then be readjusted again by the loop which can take a considerable amount of time when the baseline has drifted excessively.

There is a need to provide an electric circuitry for baseline restoration which enables to keep the baseline during high pulse activities and prevent the need to restore the baseline due to baseline droop.

### SUMMARY

The proposed approach of an electric circuitry for baseline restoration is specified in claim 1.

The electric circuitry for baseline restoration comprises an input terminal to receive an input signal having pulses above or below a baseline level. The electric circuitry for baseline restoration further comprises a baseline sampling circuit for providing a baseline output signal representing a baseline level of the input signal.

Furthermore, the electric circuitry for baseline restoration comprises an integrator circuit to receive an error signal representing an error of the determined baseline level of the input signal. The integrator circuit is configured to provide an integrator output signal being a representation of an integration of the error signal.

The electric circuitry for baseline restoration further comprises a digitization circuit to provide a digital output signal which is a digital representation of the integrator output signal. Furthermore, the electric circuitry for baseline restoration comprises an output stage to provide a baseline restoration output signal representing a corrected baseline level of the input signal. The output stage is configured to provide the baseline restoration output signal in dependence on the digital output signal.

The electric circuitry enables a reduced and, especially, a negligible baseline droop during high pulse activity periods. Without the digitization circuit and the output stage a baseline droop would occur due to integrator capacitor leakage. Furthermore, the electric circuitry prevents image artefacts from occurring in a photon counting circuitry and thus increases the spectral accuracy of the photons detected by a photon detector of the photon counting circuitry.

According to a first possible embodiment of the electric circuitry for baseline restoration, the digitization circuit comprises an analog-to-digital converter being configured to convert the integrator output signal to the digital output signal. The digitization circuit is configured to hold the digital output signal for further processing by the output stage.

The digitization circuit may be configured to hold the digital output signal for a time during which pulse activity occurs so that integrator leakage does not affect the baseline restoration output signal.

According to a possible configuration of the first embodiment of the electric circuitry for baseline restoration, the output stage may comprise a digital-to-analog converter to convert the digital output signal to the baseline restoration output signal.

This configuration of a digital-to-analog converter with current output enables the baseline restoration output signal to be provided as a correction current by the output stage.

According to a second embodiment of the electric circuitry for baseline restoration, the digitization circuit comprises a counter circuit. The counter circuit is configured to change a state of the counter circuit in dependence on a level of the integrator output signal. The counter circuit is configured to generate the digital output signal in dependence on the counter state of the counter circuit.

The counter circuit may increase its state if it is detected that the level of the integrator output signal exceeds an upper range limit. On the other hand, the counter circuit decrements its state if it is detected that the level of the integrator output signal falls below a lower range limit.

According to a possible configuration of the second embodiment of the electric circuitry for baseline restoration, the digitization circuit comprises a range detector circuit. The range detector circuit is configured to evaluate the level of the integrator output signal in relation to a first and second threshold level. The range detector circuit is configured to control the counter circuit in dependence on the evaluated level of the integrator output signal.

The range detector circuit determines if the level of the integrator output signal is within a defined range. If the level of the integrator output signal is detected to be outside the defined range, the state of the counter circuit is incremented or decremented.

According to a possible configuration of the second embodiment of the electric circuitry for baseline restoration, the range detector circuit is configured so that a range between the first and second threshold level is provided with a hysteresis

According to a possible configuration of the second embodiment of the electric circuitry for baseline restoration, the range detector circuit is configured to generate a first control signal applied to the counter circuit, if the range detector circuit evaluates the level of the integrator output signal being below the first threshold level, and to generate a second control signal applied to the counter circuit, if the range detector circuit evaluates the level of the integrator output signal being above the second threshold level. The counter circuit is configured to increment the state of the counter circuit, if the counter circuit receives the first control signal. The counter circuit is further configured to decrement the state of the counter circuit, if the counter circuit receive the second control signal.

The range detector circuit thus controls the counter circuit, i.e. the change of the counter state of the counter circuit in dependence on the detected level of the integrator output signal. The first control signal is provided by the range detector circuit to increment the state of the counter circuit, if the level of the integrator output signal is below a lower threshold level. The second control signal is provided by the range detector circuit to decrement the state of the counter circuit, if the level of the integrator output signal is above an upper threshold level.

According to a possible configuration of the second embodiment of the electric circuitry for baseline restoration, the output stage comprises a digital-to-analog converter to convert the digital output signal to an analog output voltage signal. The electric circuitry comprises an output terminal to provide the baseline restoration output signal. The output stage comprises a summation block to provide a voltage summation signal being a representation of a sum of the integrator output signal and the analog output voltage signal. The output stage comprises a transconductor stage being coupled to the output terminal. The transconductor stage is configured to convert the voltage summation signal to the baseline restoration output signal.

This configuration allows the integrator output signal and the digital output signal of the digitization circuit to be further processed to provide the baseline restoration output signal. The analog voltage output signal provided by the digital-to-analog converter of the output stage can be further processed together with the integrator output signal in a voltage domain, especially by voltage domain summation.

According to another possible configuration of the second embodiment of the electric circuitry for baseline restoration, the electric circuitry comprises an output terminal to provide the baseline restoration output signal. The output stage comprises a first transconductor stage to convert the integrator output signal to a first current signal. The first transconductor stage has a first output node to provide the first current signal. The first output node is connected to the output terminal. The output stage comprises a digital-to-analog converter to convert the digital output signal to a second current signal. The digital-to-analog converter has a second output node to provide the second current signal. The second output node is connected to the output terminal.

This configuration allows the output signal provided by the digital-to-analog converter of the output stage to be further processed together with the integrator output signal in a current domain, especially by current domain summation.

According to a modification of the second embodiment of the electric circuitry for baseline restoration, the electric circuitry comprises an arithmetic block to provide the error signal. Furthermore, the electric circuitry comprises a second digital-to-analog converter. The second digital-to-analog converter is configured to provide an analog output signal in dependence on the level of the first and second control signal of the range detector. The arithmetic block is configured to provide the error signal by subtracting the analog output signal from the baseline output signal.

This configuration prevents the generation of the baseline restoration output signal with a temporary ripple after an update of the counter circuit and summation, because the loop of the digitization circuit and the output stage needs to readjust the output of the integrator circuit back to the range in order to move the baseline back to its desired value. Ripple compensation is performed by removing the resulting counter increment voltage from the output of the integrator circuit.

According to a possible configuration of the second embodiment of the electric circuitry for baseline restoration, the digital-to-analog converter is configured to provide the analog output voltage signal with a level change representing a change of the digital output signal, when the state of the counter circuit is incremented or decremented by one step. The second digital-to-analog converter is configured to provide a level of the second analog output voltage signal in dependence on the level change of the analog output voltage signal and a gain on the integrator circuit.

This configuration enables each counter increment or decrement to be compensated by an appropriate change in the integrator output signal, if the electric circuitry uses voltage domain summation.

According to a possible configuration of the second embodiment of the electric circuitry for baseline restoration, the digital-to-analog converter is configured to provide the second current signal with a level change representing a change of the digital output signal, when the state of the counter circuit is incremented or decremented by one step. The second digital-to-analog converter is configured to provide a level of the analog output signal in dependence on the level change of the second current signal and a gain of the integrator circuit and a transconductance of the first transconductor stage.

This configuration of the electric circuitry enables each counter increment or decrement to be compensated by an appropriate change in the integrator output signal, if the electric circuitry uses current domain summation in the output stage.

According to a possible configuration of the second embodiment of the electric circuitry for baseline restoration, the counter circuit is configured to preset the counter state, or a digital code is added to an output of the counter circuit for cancelling a static leakage current from a photon detector to be coupled to the input terminal of the electric circuitry for baseline restoration. In conclusion, this configuration enables a static detector leakage current to be cancelled by pre-setting a counter value of the counter circuit or adding a digital code after the counter circuit.

A photon counting circuitry, which comprises the electric circuitry for baseline restoration according to one of the embodiments described above, is specified in claim 14.

The photon counting circuitry comprises a photon detector having a photon-sensitive area. The photon detector is configured to generate a current signal having pulses above or below a baseline. The photon detector is configured to generate a respective one of the pulses, when a photon hits the photon-sensitive area. The photon counting circuitry comprises a front-end electronic circuitry having an input side to receive the current signal and having an output side to provide an output voltage signal in response to the current signal. The photon counting circuitry further comprises an energy discriminator being connected to the front-end electronic circuitry. The energy discriminator is configured to generate a digital signal in dependence on a comparison of a level of the output voltage signal with at least one threshold value. The electric circuitry for baseline restoration is connected between the input and output side of the front-end electronic circuitry. The electric circuitry for baseline restoration receives the output voltage signal provided by the front-end electronic circuitry at the input terminal as the input signal.

A device for medical diagnostics using the principle of photon counting is specified in claim 15. The device comprises the photon counting circuitry as described above. The device for medical diagnostics may be configured as an X-ray apparatus or a computed tomography scanner.

Additional features and advantages of the electric circuitry for baseline restoration are set forth in the detailed description that follows. It is to be understood that both the foregoing general description and the following detailed description are merely exemplary, and are intended to provide an overview or framework for understanding the nature and character of the claims.

### BRIEF DESCRIPTION OF THE DRAWINGS

The accompanying drawings are included to provide further understanding, and are incorporated in, and constitute a part of, the specification. As such, the disclosure will be more fully understood from the following detailed description, taken in conjunction with the accompanying figures in which:

FIG. 1 shows a block diagram of a photon counting circuitry;

FIG. 2 illustrates a sampling method for baseline estimation;

FIG. 3 shows a baseline restorer circuit for better understanding the technical background;

FIG. 4 illustrates curves of signals of the baseline restorer circuit with a baseline drift during a high pulse activity period;

FIG. 5 shows a first embodiment of an electric circuitry for baseline restoration in a photon counting circuitry using in-loop digitization;

FIG. 6A shows a second embodiment of an electric circuitry for baseline restoration in a photon counting circuitry with a parallel digital path and voltage domain summation;

FIG. 6B shows a modification of the second embodiment of the electric circuitry for baseline restoration in a photon counting circuitry with a parallel digital path and current domain summation;

FIG. 7A shows a modification of the second embodiment of the electric circuitry for baseline restoration in a photon counting circuitry with ripple compensation and voltage domain summation;

FIG. 7B shows a modification of the second embodiment of the electric circuitry for baseline restoration in a photon counting circuitry with ripple compensation and current domain summation;

FIG. 8 shows a possible implementation of a feedback digital-to-analog converter circuit for ripple compensation;

FIG. 9 shows an embodiment of a photon counting circuitry comprising an electric circuitry for baseline restoration;

FIG. 10 illustrates curves of signals of the second embodiment of the electric circuitry for baseline restoration with a negligible baseline drift during a high pulse activity period; and

FIG. 11 shows a device for medical diagnostics.

### DETAILED DESCRIPTION OF THE EMBODIMENTS

Baseline estimation may be performed by sampling an output voltage signal provided by a front-end electronic circuitry of a photon counting system during time intervals of no pulse activity, i.e. by sampling the baseline of the output voltage signal. A sampled baseline restorer may comprise several blocks as shown for a possible implementation of a discrete time baseline restorer circuit 50′ in FIG. 3.

The baseline restorer circuit 50′ comprises a baseline sampling circuit 100 that receives an output voltage signal Vout_FE from a front-end electronic circuitry of a photon counting circuitry as input signal. The input signal Vout_FE of the baseline restorer circuit 50′ comprises pulses/peaks above a baseline level which are caused by photons incident on a photon detector of the photon counting circuitry. The baseline sampling circuit 100 may be configured as an algorithmic baseline sampler that uses an appropriate algorithm to find timeslots of no pulse activity in the input signal Vout_FE so that a level of the baseline can be extracted with a minimum amount of artefacts. The baseline sampling circuit 100 outputs a baseline output signal Vbase representing the extracted level of the baseline.

The extracted level of the baseline is compared in an arithmetic block 500 to a reference voltage Vref. The arithmetic block 500 outputs an error signal Verr=Vbase-Vref which is applied to an integrator circuit 200. The integrator circuit 200 is configured as a clocked switched capacitor integrator that integrates the error signal Verr, i.e. the difference Vbase-Vref, and provides an integrator output signal Vint. The integrator output signal Vint is converted into a baseline restoration output signal IBLR, for example a correction current, using a transconductor stage 401 of an output stage 400.

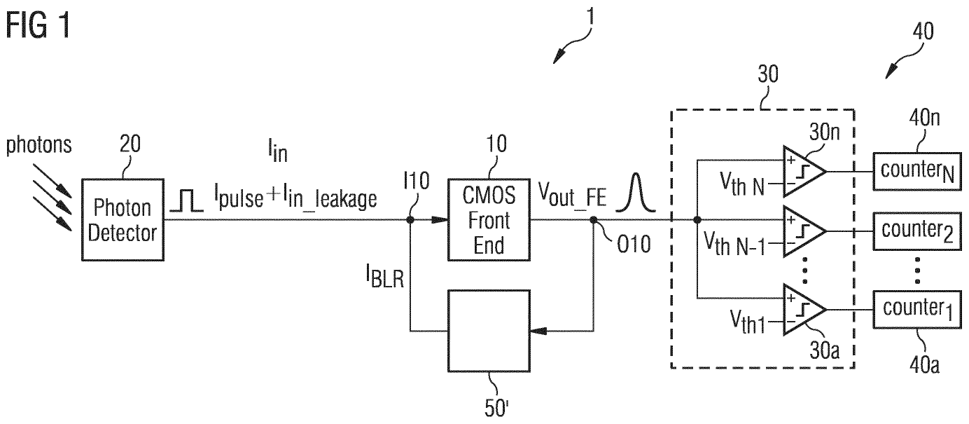

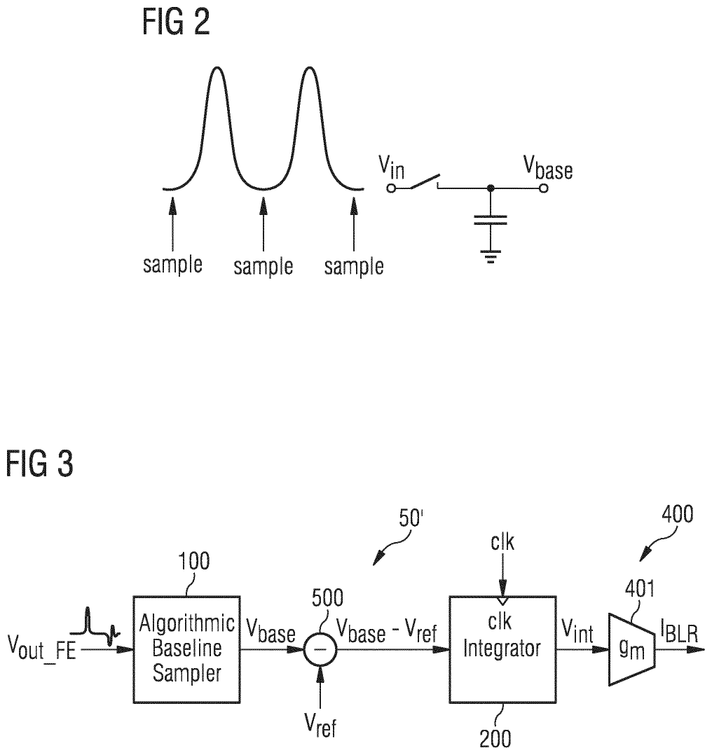

The discrete time baseline restorer circuit 50′ shown in FIG. 3 may be used as a possible implementation for an electric circuitry for baseline restoration shown in the photon counting circuitry of FIG. 1. The baseline restoration output signal IBLR is applied together with the input signal Iin from the photon detector 20 to the front-end electronic circuitry 10.

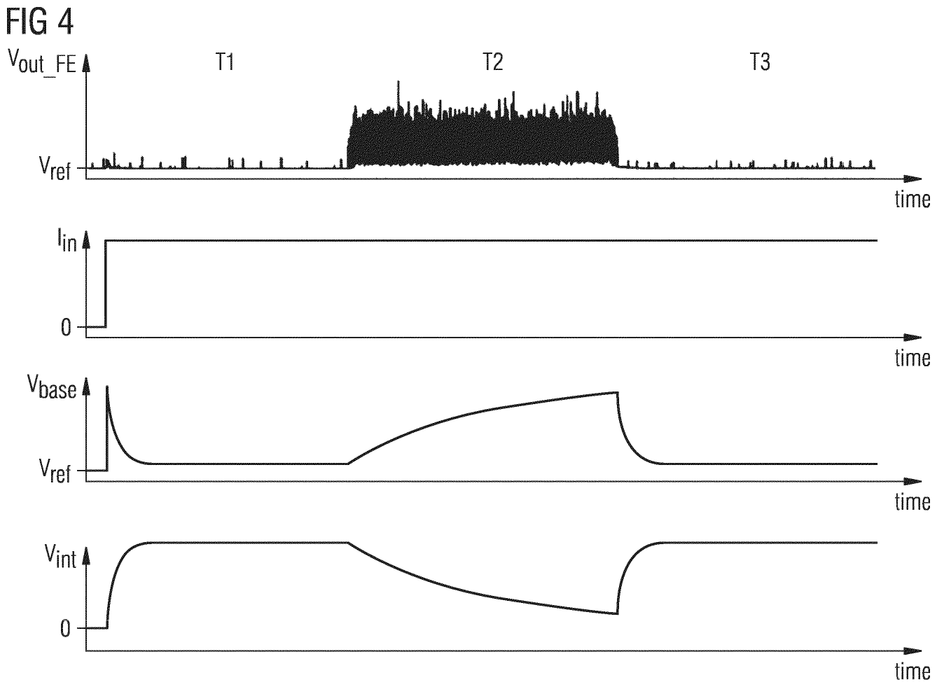

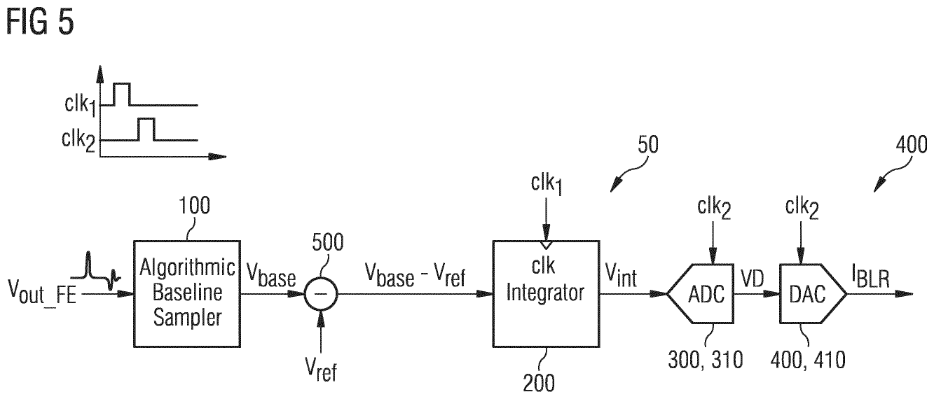

Referring to the embodiment of the baseline restorer circuit 50′ shown in FIG. 3, the major issue with this topology is that the integrator 200 can only be operated if samples of the input signal Vout_FE with no pulse activity can be found by the baseline sampling circuit 100. FIG. 4 shows curves of signals of the baseline restorer circuit 50′ of FIG. 3 during a time phase T1 of low pulse activity, a time phase T2 of high pulse activity T2 and a time phase T3 of low pulse activity. As illustrated in FIG. 4, there can be long periods of high pulse activity (time phase T2) in the input signal Vout_FE, where the integrator circuit 200 cannot be refreshed. This inevitably causes droop in the integrator output signal Vint, because the integrator hold capacitors are discharged due to parasitic leakages paths, as shown in FIG. 4.

It should be noted that periods of no refresh can easily last seconds so that even careful optimization of leakage paths will not prevent droop in the integrator output signal as the integrator output signal Vint, for example an integrator output voltage, is directly related to the baseline restoration output signal IBLR, for example a correction current, which in turn defines the level of the baseline. This results in significant baseline droop during high pulse activity periods.

The baseline droop or shift is equivalent to a drift of the energy scale, which can cause image artefacts in the application of a photon counting system and significantly impact the spectral accuracy of the photon detector. Upon change from high to low activity, the baseline can then be readjusted again by the loop in the photon counting circuitry comprising the baseline restorer circuit. However, the readjustment of the baseline can take a considerable amount of time when the baseline has drifted excessively.

FIG. 5 shows a first embodiment of an electric circuitry 50 for baseline restoration which solves the above-described problem of baseline droop during high pulse activity periods due to integrator capacitor leakage.

The electric circuitry 50 for baseline restoration comprises an input terminal 150 to receive an input signal Vout_FE which may be provided, for example as an output voltage signal from a front-end electronic circuitry of a photon counting circuitry. The input signal Vout_FE has pulses above or below a baseline level, wherein the pulses may represent a detection of a photon by a photon detector of the photon counting circuitry. The electric circuitry 50 comprises a baseline sampling circuit 100 for providing a baseline output signal Vbase that represents a baseline level of the input signal Vout_FE. The baseline sampling circuit 100 may be configured to find timeslots of no pulse activity in the input signal Vout_FE to extract the baseline level in the input signal Vout_FE, and to determine the baseline output signal Vbase.

The electric circuitry 50 further comprises an arithmetic block 500 to provide an error signal Verr. The arithmetic block 500 is configured to compare a level of the baseline output signal Vbase with a level of a reference signal Vref. The arithmetic block 500 may be configured to provide the error signal Verr as a difference of the level of the baseline output signal Vbase and the level of the reference signal Vref (Verr=Vbase-Vref). The error signal Verr thus represents an error of the determined baseline level of the input signal Vout_FE.

The electric circuitry 50 for baseline restoration further comprises an integrator circuit 200 to receive the error signal Verr. The integrator circuit 200 is configured to provide an integrator output signal Vint that is a representation of an integration of the error signal Verr. The integrator circuit 200 may be configured as a clocked integrator circuit, for example a clocked switched capacitor integrator, being clocked by a clock signal clk1.

The electric circuitry 50 for baseline restoration further comprises a digitization circuit 300 to provide a digital output signal VD being a digital representation of the integrator output signal Vint. The digitization circuit 300 may comprise an analog-to-digital converter 310 being configured to convert the integrator output signal Vint to the digital output signal VD.

The electric circuitry 50 further comprises an output stage 400 to provide a baseline restoration output signal IBLR which represents a corrected baseline level of the input signal Vout_FE. The output stage 400 is configured to provide the baseline restoration output signal IBLR, for example a correction current, in dependence on the digital output signal VD.

The output stage 400 may comprise a digital-to-analog converter 410 with current output to convert the digital output signal VD to the baseline restoration output signal IBLR, for example a correction current, to be applied to an input of a front-end electric circuitry of a photon counting system.

The analog-to-digital converter 310 of the digitization circuit 300 and the digital-to-analog converter 410 of the output stage 400 may be configured as clocked circuits which may be clocked by a clock signal clk2. FIG. 5 shows the courses of the clock signals clk1 and clk2 which are timely shifted.

The digitization circuit 300 is configured to hold the digital output signal VD for further processing by the output stage 400. The digital output signal VD can basically be held infinitely long and thus eliminates sensitivity to integrator leakage. The digitization circuit 300 may be configured to hold the digital output signal VD at least during pulse activity on the input signal Vout_FE.

The baseline sampling circuit 100 may be configured to sample the input signal Vout_FE at a first sampling time and at subsequent second sampling times, wherein the input signal Vout_FE has no pulses at the first and the second sampling times. The digitization circuit 300 may be configured to hold the digital output signal VD during the time interval between the first and the subsequent second sampling times.

Referring to FIG. 5, adding the analog-to-digital converter 310 of the digitization circuit 300 and the digital-to-analog converter 410 of the output stage 400 is expensive, both in terms of power and device area.

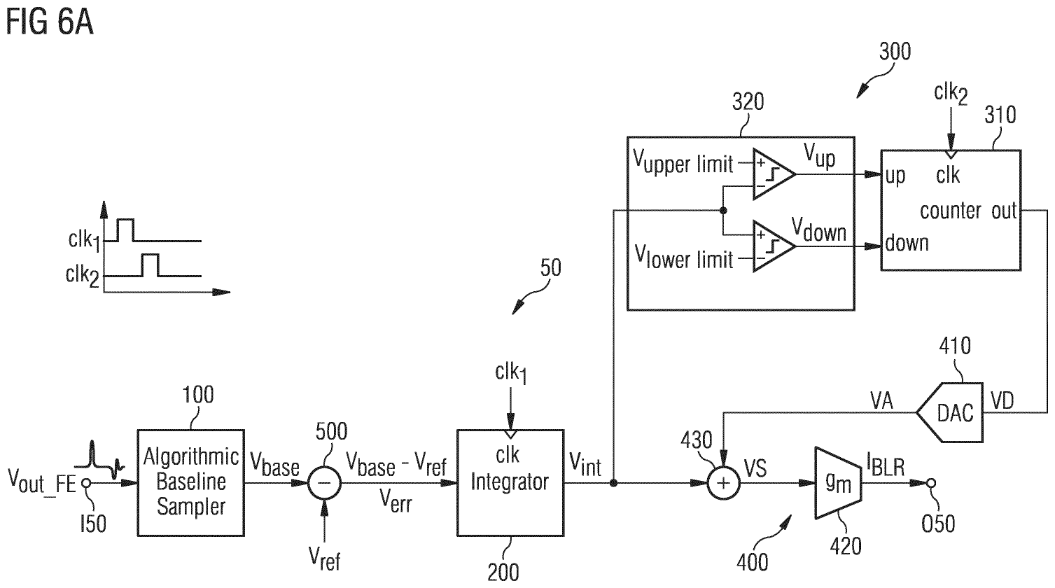

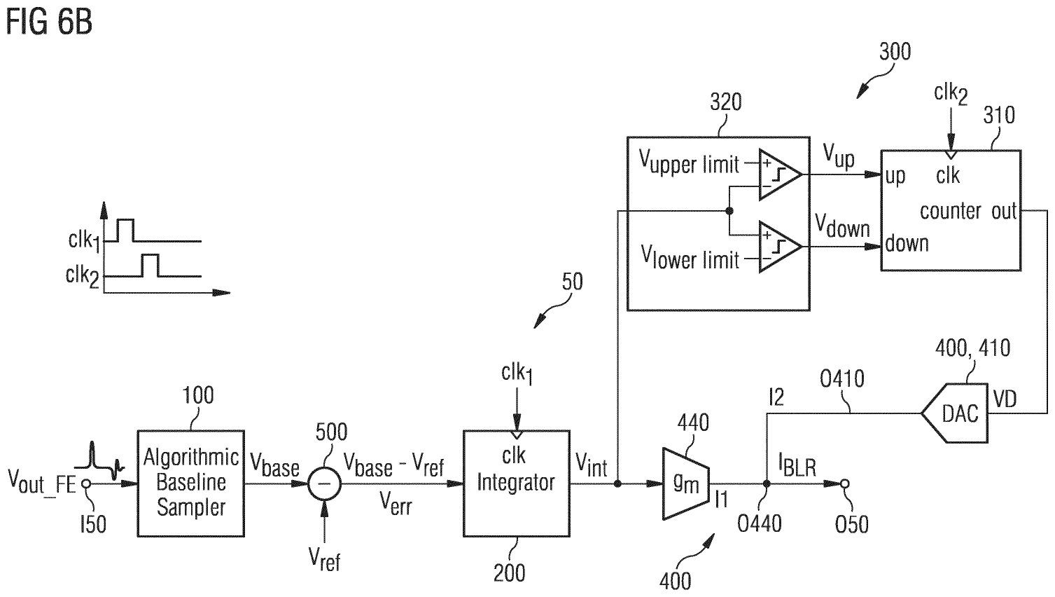

FIGS. 6A and 6B show a second embodiment of an electric circuitry 50 for baseline restoration. In FIGS. 6A and 6B, the same functional blocks as in FIG. 5 are marked with the same reference signs.

The second embodiment of the electric circuitry 50 for baseline restoration comprises an input terminal 150 to receive the input signal Vout_FE that may be provided as an output signal of a front-end electronic circuitry of a photon counting circuitry. The input signal Vout_FE has pulses above or below the baseline level. The pulses may represent a detection of a photon by a photon detector of a photon counting circuitry. The electric circuitry 50 comprises a baseline sampling circuit 100 for providing a baseline output signal Vbase, representing a baseline level of the input signal Vout_FE. The baseline output signal Vbase is determined by the baseline sampling circuit 100.

The electric circuitry 50 of FIGS. 6A and 6B further comprises an arithmetic block 500 to compare a level of the baseline output signal Vbase with a level of a reference voltage Vref, and to provide an error signal Verr. The arithmetic block 500 is configured to provide the error signal Verr by subtracting the level of the reference voltage Vref from the level of the baseline output signal Vbase. The error signal Verr thus represents an error of the determined baseline level of the input signal Vout_FE, if it is assumed that the level of the reference signal Vref corresponds to the target level of the baseline.

The electric circuitry 50 for baseline restoration of FIGS. 6A and 6B further comprises an integrator circuit 200 to receive the error signal Verr. The integrator circuit 200 is configured to provide the integrator output signal Vint which is a representation of an integration of the error signal Verr. The integrator circuit 200 may be configured as a clocked integrator circuit, for example as a clocked switched capacitor integrator, being clocked by a clock signal clk1.

The electric circuitry 50 for baseline restoration of FIGS. 6A and 6B comprises a digitization circuit 300 to provide a digital output signal VD being a digital representation of the integrator output signal Vint. Furthermore, the electric circuitry 50 for baseline restoration comprises an output stage 400 to provide a baseline restoration output signal IBLR representing a corrected baseline level of the input signal Vout_FE. The output stage 400 is configured to provide the baseline restoration output signal IBLR in dependence on the digital output signal VD.

Referring to the electric circuitries 50 for baseline restoration shown in FIGS. 6A and 6B, the digitization circuit 300 is configured as a parallel digital path. The digitization circuit 300 comprises a counter circuit 310 which may be configured as a clocked counter being clocked by a clock signal clk2. FIGS. 6A and 6B show a time diagram of clock signals clk1 to clock the integrator circuit 200 and clock signal clk2 to clock the counter circuitry 310. The clock signals may be timely shifted.

The counter circuit 310 is configured to change a state of the counter circuit 310 in dependence on a level of the integrator output signal Vint. The counter circuit 310 is further configured to generate the digital output signal VD in dependence on the counter state of the counter circuit 310.

The digitization circuit 300 comprises a range detector circuit 320. The range detector circuit 320 is configured to evaluate the level of the integrator output signal Vint in relation to a first threshold level Vlowerlimit and a second threshold level Vupperlimit. The range detector circuit 320 is configured to control the counter circuit 310 in dependence on the evaluated level of the integrator output signal Vint.

According to an embodiment of the digitization circuit 300 shown in FIGS. 6A and 6B, the range detector circuit 320 may be configured to generate a first control signal Vup applied to the counter circuit 310, if the range detector circuit 320 evaluates the level of the integrator output signal Vint below the first threshold level Vlowerlimit. The range detector circuit 320 may be further configured to generate a second control signal Vdown applied to the counter circuit 310, if the range detector circuit 320 evaluates the level of the integrator output signal Vint being above the second threshold level Vupperlimit. The counter circuit 310 is configured to increment the state of the counter circuit 310, if the counter circuit 310 receives the first control signal Vup. The counter circuit 310 may be further configured to decrement the state of the counter circuit, if the counter circuit 310 receives the second control signal Vdown.

Referring to the implementations shown in FIGS. 6A and 6B, the range detector circuit 320 may comprise a first and second comparator 321, 322. The first comparator 321 is configured to evaluate the integrator output signal Vint and to generate the first control signal Vup, if the first comparator 321 evaluates the level of the integrator output signal Vint below the first threshold level Vlowerlimit. The second comparator 322 is configured to evaluate the integrator output signal Vint and to generate the second control signal Vdown, if the second comparator 322 evaluates the level of the integrator output signal Vint above the second threshold level Vupperlimit.

Referring to the configuration of the second embodiment of the electric circuitry 50 shown in FIG. 6A, the output stage 400 comprises a digital-to-analog converter 410 to convert the digital output signal VD of the counter circuit 310 to an analog output voltage signal VA. The electric circuitry comprises an output terminal O50 to provide the baseline restoration output signal IBLR. The output stage 400 further comprises a summation block 430 to provide a voltage summation signal VS being a representation of a sum of the integrator output signal Vint and the analog output voltage signal VA. The output stage 400 comprises a transconductor stage 420 coupled to the output terminal O50. The transconductor stage 420 is configured to convert the voltage summation signal VS to the baseline restoration output signal IBLR.

Referring to the configuration of the second embodiment of the electric circuitry 50 for baseline restoration shown in FIG. 6B, the output stage 400 comprises an output terminal O50 to provide the baseline restoration output signal IBLR. The output stage 400 further comprises a first transconductor stage 440 to convert the integrator output signal Vint to a first current signal I1. The first transconductor stage 440 has a first output node O440 to provide the first current signal I1. The first output node O440 is connected to the output terminal O50. The output stage 400 comprises a digital-to-analog converter 410 with current output to convert the digital output signal VD to a second current signal 12. The digital-to-analog converter has a second output node O410 to provide the second current signal 12. The second output node O410 is connected to the output terminal O50.

The functioning of the parallel digital path of the electric circuitries 50 for baseline restoration shown in FIGS. 6A and 6B is described below.

The range detector circuit 320 determines if the level of the integrator output signal Vint is within a defined boundary being set by the first threshold level Vlowerlimit and the second threshold level Vupperlimit. This boundary is set to keep the maximum droop to a negligible level. If the level of the integrator output signal Vint moves outside this boundary, the counter circuit 310 is triggered to incrementally change the digital representation of the required integrator output voltage. If the level of the integrator output signal Vint exceeds the upper range limit, the counter state of the counter circuit is increased by one. If the level of the integrator output signal Vint falls below the lower limit Vlowerlimit, the counter state of the counter circuit 310 is decremented. The digital output signal VD representing the counter value is fed into the digital-to-analog converter 410 of the output stage 400.

Referring to the configuration of the second embodiment of the electric circuitry 50 for baseline restoration, the analog output voltage signal VA provided by the digital-to-analog converter 410 is added by the summation block 430 to the integrator output signal Vint so that the sum drives the input of the transconductor stage 420. The second embodiment of the electric circuitry 50 for baseline restoration shown in FIG. 6A is thus provided with a parallel digital path and voltage domain summation.

Alternatively, referring to the implementation of the second embodiment of the electric circuitry 50 for baseline restoration shown in FIG. 6B, summation is performed in the current domain. The implementation of the electric circuitry 50 for baseline restoration shown in FIG. 6B is thus provided with a parallel digital path and current domain summation.

Referring to the electric circuitries 50 of FIGS. 6A and 6B, after summation the baseline restoration loop will readjust the integrator output back to within the defined range in order to keep the output current of the transconductor stage, and thus the baseline, constant.

In conclusion, the second embodiment of the electric circuitry 50 for baseline restoration shown in FIGS. 6A and 6B introduces a concept that maintains a fast analog path and a slow digital path that tracks the low frequency component in the integrator output signal Vint, for example an integrator output voltage. Storing the low frequency component digitally highly reduces the effective voltage range of the integrator output, thus limiting the maximum droop significantly, i.e. the integrator circuit 200 can droop no more than its maximum output voltage which is constrained within a tight boundary.

The implementations for the electric circuitries 50 for baseline restoration according to the second embodiment, as shown in FIGS. 6A and 6B, may still suffer from a temporary ripple after counter update and summation, because the digitization loop needs to readjust the integrator output back to the range in order to move the baseline back to its desired value.

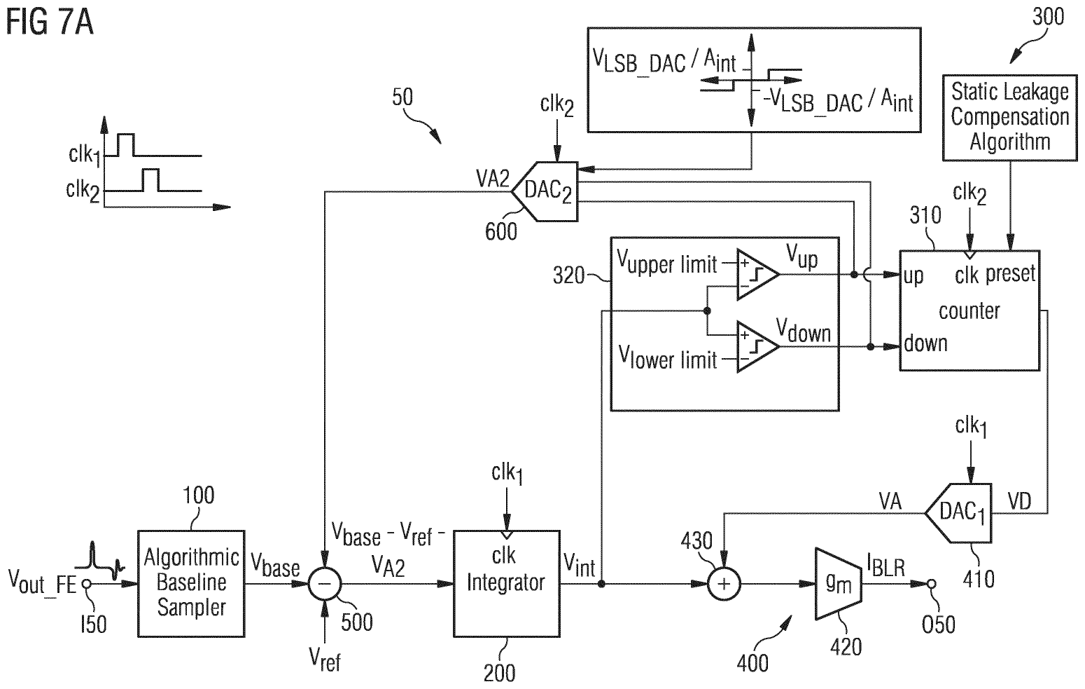

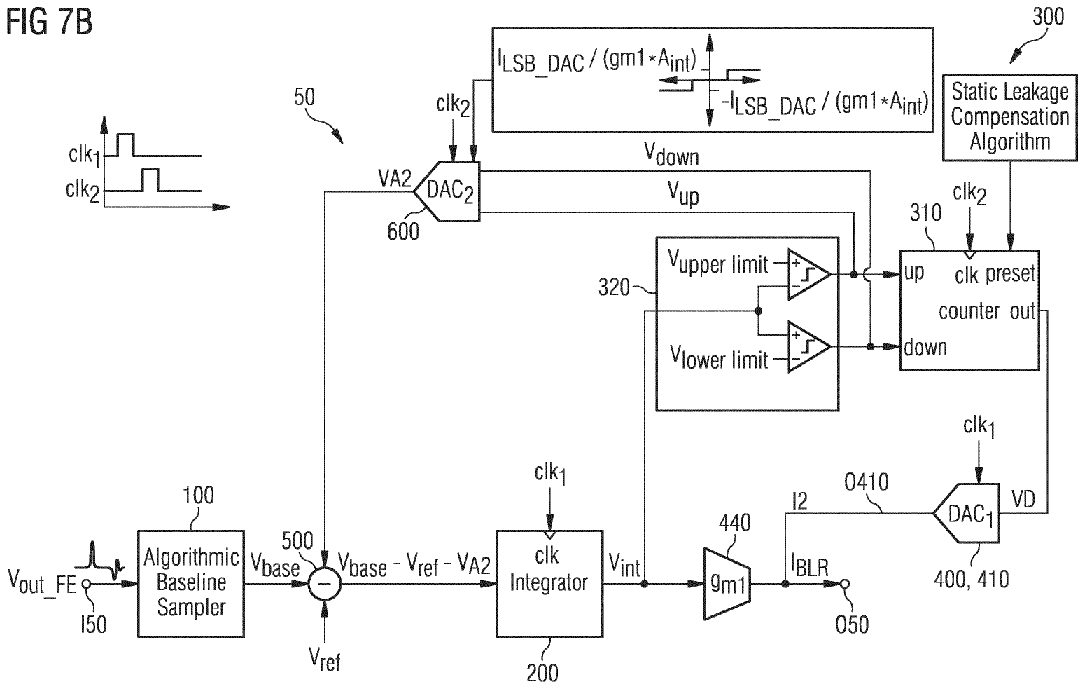

In order to avoid this temporary ripple, FIGS. 7A and 7B show a modification of the second embodiment of the electric circuitry 50 for baseline restoration, where the effective voltage increment caused by a counter update is directly subtracted from the integrator output without any loop interaction required, i.e. the level of the integrator output signal will be directly moved to the right value and the baseline restoration output signal IBLR, for example an output current, is not affected by the transfer from the integrator output signal Vint to counter state.

In FIGS. 7A and 7B, the same functional blocks as already described in FIGS. 6A and 6B are marked with the same reference signs. The embodiment of the electric circuitry 50 for baseline restoration shown in FIG. 7A is based on the voltage domain summation concept shown in FIG. 6A. The implementation of the embodiment of the electric circuitry 50 for baseline restoration shown in FIG. 7B is based on the current domain summation concept, as described with reference to FIG. 6B.

According to the embodiment of the electric circuitries 50 for baseline restoration shown in FIGS. 7A and 7B, the electric circuitries 50 comprise a second digital-to-analog converter 600. The second digital-to-analog converter 600 is realized as a clocked circuit. The second digital-to-analog converter 600 is configured to provide an analog output signal VA2 in dependence on the level of the first and second control signal Vup, Vdown provided by the range detector circuit 320. The arithmetic block 500 is configured to provide the error signal Verr by subtracting the analog output signal VA2 and the reference signal Vref from the baseline output signal Vbase (Verr=Vbase−Vref−VA2).

Referring to the voltage domain summation implementation of the second embodiment of the electric circuitry 50 for baseline restoration shown in FIG. 7A, the digital-to-analog converter 410 is configured to provide the analog output voltage signal VA with a level change VLSB_DAC representing a change of the digital output signal VD, when the state of the counter circuit 310 is incremented or decremented by one step. The second digital-to-analog converter 600 is configured to provide a level of the analog output signal VA2 in dependence on the level change VLSB_DAC of the analog output voltage signal VA and a gain Aint of the integrator circuit 200.

Referring to the current domain summation implementation of the second embodiment of the electric circuitry 50 for baseline restoration shown in FIG. 7B, the digital-to-analog converter 410 with current output is configured to provide the second current signal 12 with a level change ILSB_DAC representing a change of the digital output signal VD, when the state of the counter circuit 310 is incremented or decremented by one step. The second digital-to-analog converter 600 is configured to provide a level of the analog output signal VA2 in dependence on the level change ILSB_DAC of the second current signal 12 and a gain Aint of the integrator circuit 200 and a transconductance gm1 of the first transconductor stage 440.

According to the proposed embodiment of the electric circuitry 50 for baseline restoration, ripple compensation is performed by removing the resulting counter increment voltage from the integrator output. The proposed circuit topology shown in FIGS. 7A and 7B will therefore transfer the integrator output signal Vint, for example an integrator output voltage, to digital over time, keeping the output signal in a defined range to minimize possible droop.

In the voltage domain summation implementation of the second embodiment of the electric circuitry 50 for baseline restoration shown in FIG. 7A, a voltage equal to VLSB_DAC/Aint is added or subtracted during the subsequent integration phase, where VLSB_DAC refers to the LSB of the digital-to-analog converter 410 that converts the counter output to analog, and Aint denotes the integrator voltage gain.

According to the current domain implementation of the second embodiment of the electric circuitry 50 for baseline restoration, a voltage equal to ILSB_DAC/(gm1*Aint) is added or subtracted with gm1 denoting the transconductance of the transconductor stage 440.

Thus, according to both implementations of the second embodiment of the electric circuitry 50 for baseline restoration shown in FIGS. 7A and 7B, each counter increment or decrement is precisely compensated by an appropriate change in the integrator output signal, for example an integrator output voltage.

In the above-described implementations of the electric circuitry 50 for baseline restoration shown in FIGS. 7A and 7B, an oscillation state is possible where the counter ripples by one LSB back and forth in the presence of noise in the case that the integrator output signal Vint is close to its range boundary set by the first threshold level Vlowerlimit and the second threshold level Vupperlimit. While this is theoretically not an issue, it is undesirable in practice because a counter-increment/decrement and the proportional compensation at the integrator output can still cause switching spikes which would appear as a periodic disturbance during the oscillation state.

In order to avoid this situation, according to a possible embodiment of the electric circuitry 50 for baseline restoration, a hysteresis may be added to the range checker boundary. In conclusion, according to this embodiment, the range detector circuit 320 is configured so that a range between the first threshold level Vlowerlimit and the second threshold level Vupperlimit is provided with a hysteresis. Upon startup, the target range is set and once the integrator output signal is within this range, the boundary is widened by a value large enough to prevent switching back due to noise. Once the integrator output signal falls outside the widened range, the boundary is set back to the target value.

Referring to FIGS. 7A and 7B, according to a modification of the second embodiment of the electric circuitry 50 for baseline restoration, the counter circuit 310 may be configured to preset the counter state, or a digital code is added to an output of the counter circuit 310 for cancelling a static leakage current from a photon detector 20 to be coupled to the input terminal 150 of the electric circuitry. This approach allows a static component to be imposed on the baseline restoration output signal IBLR by presetting the counter value or adding the digital code after the counter circuit. This preset code may be determined during a calibration phase such that the static detector leakage is cancelled.

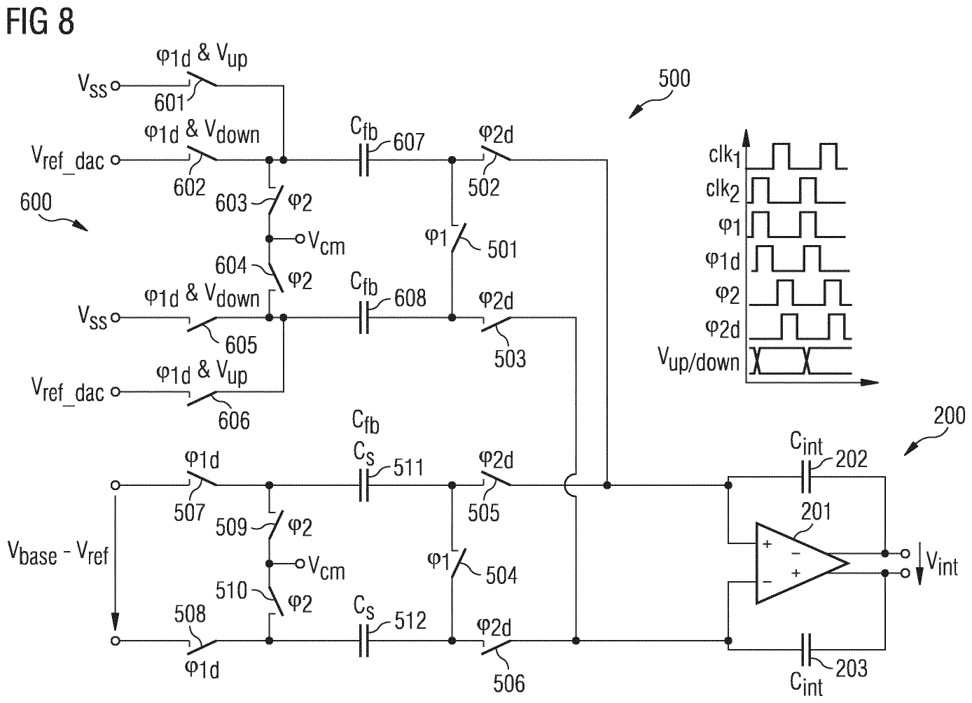

FIG. 8 depicts an implementation of the second digital-to-analog converter 600 for ripple compensation. The second digital-to-analog converter 600 is implemented as a switched capacitor network comprising controllable switches 601, . . . , 606 and feedback capacitors 607, 608. The controllable switches 601, 602 and 605, 606 are connected to voltage potentials Vref_dac and Vss, as illustrated in FIG. 8. The controllable switches 603, 604 are connected to a common mode voltage Vcm. The second digital-to-analog converter 600 is realized as a clocked circuit. The controllable switches 601, . . . , 606 are controlled by control signals old and control signals Vup, Vdown provided by the range detector circuit 320.

FIG. 8 further shows the coupling of the second digital-to-analog converter 600 to the arithmetic block 500 and the integrator circuit 200. The arithmetic block 500 to provide the error signal Verr=Vbase-Vref-VA2 comprises controllable switches 501, . . . , 506 which are controlled by control signals o1 and o2d, and a switched capacitor network comprising sampling capacitors 511, 512 and controllable switches 507, . . . , 510 being controlled by control signals old and 42, as depicted in FIG. 8.

The curves of clock signals clk1, clk2, and control signals q1, qld, q2, 2d and Vup/down are also illustrated in FIG. 8.

The integrator circuit 200 comprises a differential operational amplifier 201 to provide the integrator output signal Vint at its output side. Integrator capacitors 202 and 203 are arranged in respective feedback paths between the input and output side of the differential operational amplifier 201.

Referring to FIG. 8, subtraction of a value VLSB_DAC/Aint for the voltage domain summation configuration of the baseline restorer circuit 50 or subtraction of a value ILSB_DAC/(gm1*Aint) for the current domain summation configuration of the baseline restorer circuit 50 is performed by sampling a DAC reference voltage Vref_dac on capacitors 607, 608 during the high phase of control signal @1 and integrating the charge on integrator capacitors 202, 203 during the high phase of control signal ø2. The sign of this operation is determined by the sample switches used that are controlled by the range checker output control signals Vdown and Vup. In order to achieve exact cancellation the following must apply:

$$Aint * Vref\_dac = VLSB\_DAC$$

$$with$$

$$Aint = \frac{Cfb}{Cint}$$

wherein Cfb denotes a capacitance of capacitors 607, 608 and Cint denotes a capacitance of feedback capacitors 202, 203. This yields for Cfb:

$$C f b = \frac{VLSB\_DAC}{Vref\_dac} * C i n t$$

In an alternative embodiment, the second digital-to-analog converter 600 for ripple compensation may be implemented as shown in FIG. 8, with the difference that instead of integrating a charge Cfb*Vref_dac by the switched capacitor network, a fixed current is injected in the integrator virtual grounds for a time Tint, leading to an integrated charge of Tint×Iref_dac. This requires that Cfb*Vref_dac=Tint×Iref_dac.

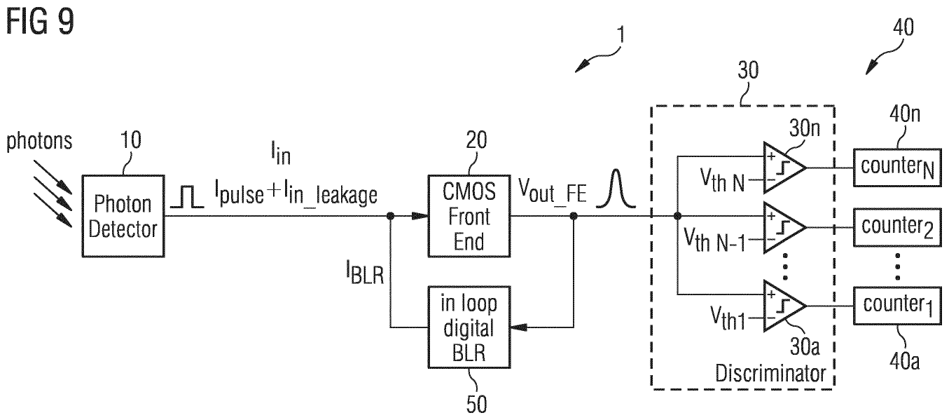

The proposed embodiments of an electric circuitry 50 for baseline restoration, especially those embodiments shown and described with reference to FIGS. 5 to 8, may be used in a photon counting circuitry 1, as shown in FIG. 9.

The photon counting circuitry 1 comprises a photon detector 20 having a photon sensitive area 21. The photon detector 20 is configured to generated a current signal Iin having pulses Ipulse above or below a baseline. The photon detector 20 is configured to generate a respective one of the pulses Ipulse, when a photon hits the photon sensitive area 21. The current signal Iin may also have a detector leakage current component Iin leakage in case of a DC path from an input of a front-end electronic circuitry 10 and the photon detector 20.

The front-end electronic circuitry 10 of the photon counting circuitry 1 has an input side to receive the current signal Iin and having an output side to provide an output voltage signal Vout_FE in response to the current signal Iin. Furthermore, photon counting circuitry 1 comprises an energy discriminator 30 being connected to the front-end electronic circuitry 10. Energy discriminator 30 is configured to generate a digital signal in dependence on a comparison of a level of the output voltage signal Vout_FE with at least one threshold value. The discriminator's output is then fed into counter circuits 40a, . . . , 40n of counter 40. The number of counts is proportional to the number of incident photons. Having multiple discriminator circuits 30a, . . . , 30n and counter circuits 40a, . . . , 40n will give information on the energy level of each incident photon.

The electric circuitry 50 for baseline restoration, as described above with reference to one of the embodiments shown in FIGS. 5-8 is connected between the input and output side of the front-end electronic circuitry 10. The electric circuitry 50 for baseline restoration receives the output voltage signal Vout_FE provided by the front-end electronic circuitry 10 at the input terminal 150 as input signal, and provides the baseline restoration output signal IBLR at its output that is fed to the input of the electronic front-end electronic circuitry 10.

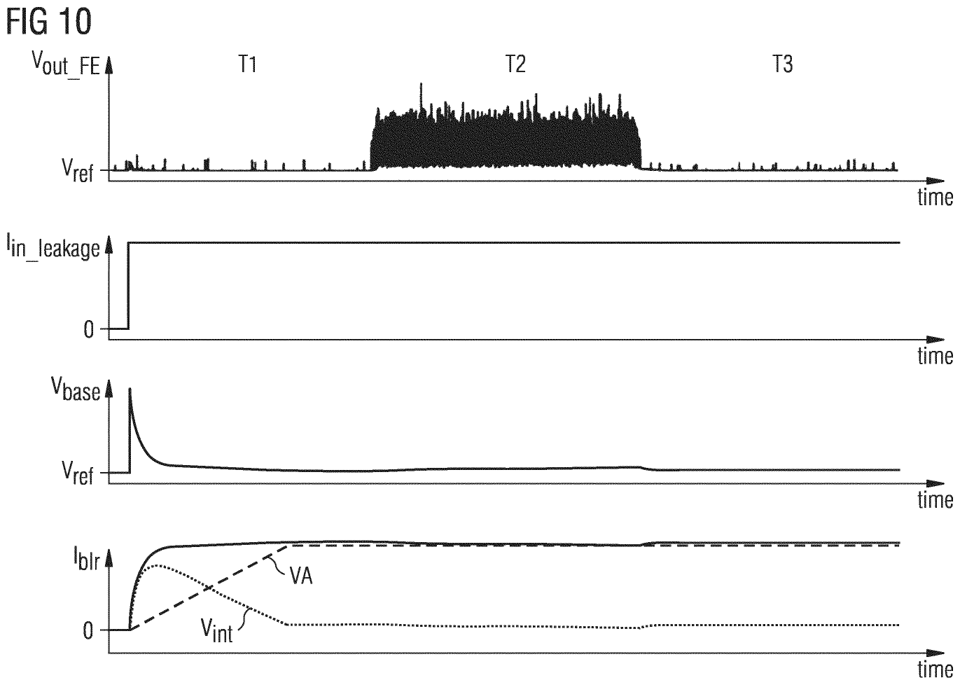

FIG. 10 illustrates the functionality of the electric circuitry 50 for baseline restoration implemented as shown in FIG. 7A by means of curves of signals of the electric circuitry 50 during a first time phase t1 of low pulse activity, a second time phase t2 of high pulse activity, and a third time phase t3 of low pulse activity.

Initially the input leakage current Iin leakage of the photon detector 20 steps up, and the electric circuitry 50 for baseline restoration is able to compensate for it during the time of low pulse activity. The integrator output voltage Vint provided at the output of the integrator circuit 200 is gradually transferred to the digitization circuit 300, in particular the counter circuit 310, and at the beginning of the time phase t2, when high pulse activity starts, the baseline restoration output signal IBLR, for example a correction current, can effectively be held constant except for the droop caused by the integrator output residue. However, this impact is negligible due to the small range enforced by the range detector circuit. Once pulse activity has faded, the baseline restorer circuit 50 re-establishes the former integrator output residue, resulting in a small baseline adjustment.

The topology of the electric circuitry 50 for baseline restoration described according to the first, second and third embodiment and illustrated in FIGS. 5 to 8 allows the baseline to be stabilized at the front-end channel output. The electric circuitry 50 for baseline restoration needs low area and is provided with power overhead that allows long periods of pulse activity to be bridged without compromising baseline stability. In particular, the proposed embodiments of the electric circuitry 50 for baseline restoration allow to build a sample based baseline restorer that does not suffer from the effects of integrator leakage during periods of high pulse activity.

As the proposed approach of an electric circuitry 50 for baseline restoration is described as being part of a photon counting system, it can be basically be used in any application that requires low noise intensity measurements and possibly also spectral information. This includes medical imaging, spectroscopy, security scanners, etc.

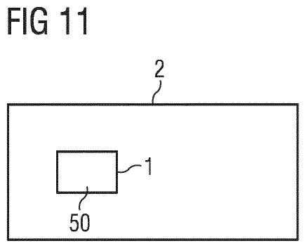

FIG. 11 shows an example of an application, where a photon counting circuitry 1 equipped with an electric circuitry 50 for baseline restoration is provided in a device 2 for medical diagnostics. The device 2 may be configured, for example, as an X-ray apparatus or a computed tomography scanner.

The embodiments of the electric circuitry for baseline restoration and the photon counting circuitry disclosed herein have been discussed for the purpose of familiarizing the reader with novel aspects of the design of the electric circuitry for baseline restoration and the photon counting circuitry. Although preferred embodiments have been shown and described, many changes, modifications, equivalents and substitutions of the disclosed concepts may be made by one having skill in the art without unnecessarily departing from the scope of the claims.

In particular, the design of the electric circuitry for baseline restoration and the design of the photon counting circuitry are not limited to the disclosed embodiments, and gives examples of many alternatives as possible for the features included in the embodiments discussed. However, it is intended that any modifications, equivalents and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

This patent application claims the priority of German patent application with application No. 102022100715.4, the disclosure content of which is hereby incorporated by reference.

References

| | |
|---|---|
| 1 | photon counting circuitry |
| 2 | device for medical diagnostics |
| 10 | front-end electronic circuitry |
| 20 | photon detector |
| 21 | photon sensitive area |
| 30 | energy discriminator |
| 40 | counter |
| 50 | electric circuitry for baseline restoration |
| I50 | input terminal |
| O50 | output terminal |
| 100 | baseline sampling circuit |
| 200 | integrator circuit |
| 201 | differential operational amplifier |
| 202, 203 | integrator capacitor |
| 300 | digitization circuit |
| 310 | counter circuit |
| 320 | range detector circuit |
| 321, 322 | comparator |
| 400 | output stage |
| 410 | digital-to-analog converter |
| 420 | transconductor stage |
| 430 | summation block |
| 440 | transconductor stage |
| 500 | arithmetic block |
| 600 | second digital-to-analog converter |
| 700 | static leakage compensation algorithm block |
| 501, . . ., 510 | controllable switches |
| 511, 512 | sampling capacitors |
| 601, . . ., 606 | controllable switches |
| 607, 608 | feedback capacitors |
| VD | digital output signal |
| VA | analog output voltage signal |
| Iin | input current |
| Ipulse | current pulse |
| In_leakage | detector leakage current |
| Vout_FE | input signal/output signal |
| Vbase | baseline output signal |
| Vref | reference signal |
| Verr | error signal |
| Vint | integrator output signal |
| IBLR | baseline restoration output |
| clk1, clk2 | clock signal |
| Vupperlimit, Vlowerlimit | threshold level |
| Vup, Vdown | control signal |
| Φ1, φ1d, φ2, φ2d | control signals |

1. An electric circuitry for baseline restoration, comprising:
an input terminal to receive an input signal having pulses above or below a baseline level,
a baseline sampling circuit for providing a baseline output signal representing a baseline level of the input signal,
an integrator circuit to receive an error signal representing an error of the baseline level of the input signal, the integrator circuit being configured to provide an integrator output signal being a representation of an integration of the error signal,
a digitization circuit to provide a digital output signal being a digital representation of the integrator output signal,
an output stage to provide a baseline restoration output signal representing a corrected baseline level of the input signal, the output stage being configured to provide the baseline restoration output signal in dependence on the digital output signal.

2. The electric circuitry of claim 1,
wherein the digitization circuit comprises an analog-to-digital converter being configured to convert the integrator output signal to the digital output signal,
wherein the digitization circuit is configured to hold the digital output signal for further processing by the output stage.

3. The electric circuitry of claim 1,
wherein the output stage comprises a digital-to-analog converter to convert the digital output signal to the baseline restoration output signal.

4. The electric circuitry of claim 1,
wherein the digitization circuit comprises a counter circuit,
wherein the counter circuit is configured to change a state of the counter circuit in dependence on a level of the integrator output signal,
wherein the counter circuit is configured to generate the digital output signal in dependence on the state of the counter circuit.

5. The electric circuitry of claim 4,
wherein the digitization circuit comprises a range detector circuit,
wherein the range detector circuit is configured to evaluate the level of the integrator output signal in relation to a first and second threshold level,
wherein the range detector circuit is configured to control the counter circuit in dependence on the evaluated level of the integrator output signal.

6. The electric circuitry of claim 5,
wherein the range detector circuit is configured so that a range between the first and second threshold level is provided with a hysteresis.

7. The electric circuitry of claim 5,
wherein the range detector circuit is configured to generate a first control signal applied to the counter circuit, if the range detector circuit evaluates the level of the integrator output signal being below the first threshold level, and to generate a second control signal applied to the counter circuit, if the range detector circuit evaluates the level of the integrator output signal being above the second threshold level,
wherein the counter circuit is configured to increment the state of the counter circuit, if the counter circuit receives the first control signal,
wherein the counter circuit is configured to decrement the state of the counter circuit, if the counter circuit receives the second control signal.

8. The electric circuitry of claim 7, comprising:
wherein the output stage comprises a digital-to-analog converter to convert the digital output signal to an analog output voltage signal,
an output terminal to provide the baseline restoration output signal,
wherein the output stage comprises a summation block to provide a voltage summation signal being a representation of a sum of the integrator output signal and the analog output voltage signal,
wherein the output stage comprises a transconductor stage being coupled to the output terminal,
wherein the transconductor stage is configured to convert the voltage summation signal to the baseline restoration output signal.

9. The electric circuitry of claim 7, comprising:
an output terminal to provide the baseline restoration output signal,
wherein the output stage comprises a first transconductor stage to convert the integrator output signal to a first current signal, wherein the first transconductor stage has a first output node to provide the first current signal, and wherein the first output node is connected to the output terminal,
wherein the output stage comprises a digital-to-analog converter to convert the digital output signal to a second current signal, wherein the digital-to-analog converter has a second output node to provide the second current signal, and wherein the second output node is connected to the output terminal.

10. The electric circuitry of claim 8, comprising:
an arithmetic block to provide the error signal,
a second digital-to-analog converter,
wherein the second digital-to-analog converter is configured to provide an analog output signal in dependence on the level of the first and second control signal,
wherein the arithmetic block is configured to provide the error signal by subtracting the analog output signal from the baseline output signal.

11. The electric circuitry of claim 10,
wherein the digital-to-analog converter is configured to provide the analog output voltage signal with a level change representing a change of the digital output signal, when the state of the counter circuit is incremented or decremented by one step,
wherein the second digital-to-analog converter is configured to provide a level of the analog output signal in dependence on the level change of the analog output voltage signal and a gain of the integrator circuit.

12. The electric circuitry of claim 9, comprising:
an arithmetic block to provide the error signal,
a second digital-to-analog converter,
wherein the second digital-to-analog converter is configured to provide an analog output signal in dependence on the level of the first and second control signal,
wherein the arithmetic block is configured to provide the error signal by subtracting the analog output signal from the baseline output signal,
wherein the digital-to-analog converter is configured to provide the second current signal with a level change representing a change of the digital output signal, when the state of the counter circuit is incremented or decremented by one step,
wherein the second digital-to-analog converter is configured to provide a level of the analog output signal in dependence on the level change of the second current signal and a gain of the integrator circuit and a transconductance of the first transconductor stage.

13. The electric circuitry of the claim 4,
wherein the counter circuit is configured to preset the state of the counter circuit, or a digital code is added to an output of the counter circuit for cancelling a static leakage current from a photon detector to be coupled to the input terminal.

14. A photon counting circuitry, comprising:
a photon detector having a photon sensitive area, the photon detector being configured to generate a current signal having pulses above or below a baseline, wherein the photon detector is configured to generate a respective one of the pulses, when a photon hits the photon sensitive area,
a front-end electronic circuitry having an input side to receive the current signal and having an output side to provide an output voltage signal in response to the current signal,
an energy discriminator being connected to the front-end electronic circuitry, the energy discriminator being configured to generate a digital signal in dependence on a comparison of a level of the output voltage signal with at least one threshold value,
the electric circuitry for baseline restoration according to claim 1 being connected between the input side and the output side of the front-end electronic circuitry, wherein the electric circuitry for baseline restoration receives the output voltage signal provided by the front-end electronic circuitry at the input terminal as the input signal.

15. A device for medical diagnostics, comprising:
a photon counting circuitry of claim 14,
wherein the device is configured as an X-ray apparatus or a computed tomography scanner.
